(19) United States
(12) Patent Application Publication
(10) Pub. No.: US 2008/0054238 A1
(43) Pub. Date: Mar. 6, 2008

(54) Hoist support post and method of forming same

(75) Inventors: Richard L. Craig, Lisbon, OH (US); Jason R. Craig, Lisbon, OH (US); Charles W. Bell, Lisbon, OH (US)

Correspondence Address: SAND & SEBOLT, AEGIS TOWER, SUITE 1100, 4940 MUNSON STREET, NW, CANTON, OH, 44718-3615, US

(73) Assignee: R.L. Craig, Inc., Lisbon, OH (US)

(21) Appl. No.: 11/515,253

(22) Filed: Sep. 1, 2006

(51) Int. Cl. B66F 3/12

(52) U.S. Cl. 254/7 R

(57) ABSTRACT

A hoist apparatus for positioning and supporting a load includes an elongated hollow tubular post extruded of aluminum and formed with a plurality of substantially circular holes formed in certain of the walls adjacent a hollow interior of the post. The holes extend throughout the length of the post and have only a short end section thereof adjacent the end edges of the post tapped to provide internal threads for receiving threaded fasteners for mounting the post on a support base and for securing a drive screw end cap plate on the top of the post.

### BACKGROUND OF THE INVENTION

1. Technical Field

The invention relates to a hoist apparatus, and in particular to an improved support post on which a load is moveably supported by a carriage and moved therealong by a drive screw extending along the length of the post, and to the method of forming the support post.

2. Background Information

In many manufacturing processes, it is necessary to support various equipment, materials, etc. at locations along and adjacent to a production line for use in the manufacturing process. Furthermore, certain of these support apparatus often must be moved between various production lines and work stations. Various hoist apparatus and mounting standards have been developed for accurately supporting a piece of equipment or other object, preferably on a moveable stand, which enables the supported equipment to be accurately positioned vertically along the hoist particularly for use in a manufacturing process. Some examples of such hoists are shown in U.S. Pat. Nos. 4,971,292, 4,593,833, and 5,544,860.

Many prior art hoist apparatus use some type of main support structure or post which extends upwardly from a fixed or moveable base for accurately positioning and moving a piece of equipment along the post. Some of these hoist constructions such as shown in U.S. Pat. No. 4,971,292 use a hollow tube which supports and houses the mechanism, such as a drive screw, for accurately moving the equipment support carriage vertically along the support post. Other hoist mechanisms such as shown in U.S. Pat. No. 5,544,860 uses an elongated post which includes an extruded portion that provides a central recess in which the drive screw is located and a pair of side guide channels on which rollers of the carriage are moved and seated therein. However, the extruded portion of this prior art support is solid in cross section and requires the drilling of attachment holes and the subsequent tapping of the drilled holes to form threaded holes for receiving attachment bolts.

Although these prior art support posts have proved satisfactory for their intended purpose, it is difficult to provide an easy means of securing the post on a support base and/or mounting the drive screw thereon without requiring various components and manufacturing steps for achieving these results. Therefore, the need exists for a simple, yet efficient post construction and to the method of forming the same for use in a hoist apparatus.

### BRIEF SUMMARY OF THE INVENTION

One feature of the present invention includes extruding a support post, preferably of aluminum with a cross-sectional configuration which includes a plurality of walls forming a hollow interior, a concave recess formed in the front wall thereof for receiving a drive screw for a carriage having rollers which are moved along a pair of arcuate-shaped guide channels formed in opposed side walls of the post. Most importantly the post is formed with a plurality of holes during the extrusion process which extend longitudinally throughout the length of the extruded post wherein a short section of the holes at the ends of the post are subsequently tapped to provide a short section of internal threads for receiving attachment bolts for mounting an end cap or other support mechanism of the drive screw thereon and/or for mounting the post on a support base.

A further feature of the present invention is to form two of the elongated holes, which are subsequently formed with short internally threaded sections, in a back wall of the post with two other of the holes being formed in the front wall of the post, wherein each hole is formed by a pair of arcuate flanges, which form a partial hole circular in cross section, which flanges extend inwardly into the hollow interior of the extruded post.

Another aspect of the present invention is to provide such a hoist apparatus, and in particular a support post therefore, which provides an extremely rigid lightweight support which can be manufactured to close tolerances by a simple extrusion process and subsequent tapping of a plurality of holes formed in the post during the extrusion process, eliminating numerous manufacturing steps and costs heretofore required for forming a supporting post for fixed or portable hoist apparatus.

Another feature of the invention is that by extruding the post with a hollow interior the elongated holes can be formed adjacent thereto, which are subsequently tapped without first requiring the drilling of holes in a solid extrusion as heretofore required. This saves both material cost and weight, and manufacturing steps.

These features and advantages are obtained by an improved hoist apparatus of the present invention which is intended for lifting, supporting and positioning a load, the general nature of which includes an elongated post having a back wall, a pair of side walls with arcuate guide channels formed thereon, and a front wall having a concave recess formed thereon, a base for supporting the post in an upright position, a drive screw extending within the recess of the front wall, a carriage for supporting a load, the carriage being operatively connected to the drive screw, and means for engaging each of the respective guide channels for movement of the carriage along the post, wherein the improvement comprises the post being formed of extruded aluminum having a hollow interior and a plurality of substantially smooth holes formed in certain of the walls and extending throughout the length of the post between end edges of said post, and wherein the holes have an internally threaded section located adjacent at least one of the end edges for receiving threaded fasteners therein.

### BRIEF DESCRIPTION OF THE SEVERAL VIEWS OF THE DRAWINGS

Preferred embodiments of the invention, illustrative of the best modes in which Applicant contemplates applying the principles, are set forth in the following description and are shown in the drawings and are particularly and distinctly pointed out and set forth in the appended claims.

FIG. 1 is a perspective view of a hoist apparatus embodying a first embodiment of the improved support post of the present invention in operating position supporting a load shown in dot dashed lines.

FIG. 2 is a perspective view of a section of the first embodiment of the support post of the present invention.

FIG. 3 is a cross-sectional view of the support post shown in FIG. 2.

FIG. 4 is an enlarged fragmentary sectional view taken on line 4-4, FIG. 3 showing the support post being attached to a drive screw end cap at its upper end and mounted on a base at its lower end.

FIG. 5 is a perspective view similar to FIG. 1 showing a second embodiment of the improved support post.

FIG. 6 is a perspective view of a section of the second embodiment support post as shown in FIG. 5.

FIG. 7 is a cross-sectional view of the support post of FIGS. 5 and 6.

FIG. 8 is an enlarged sectional view taken on line 8-8, FIG. 7 showing a drive screw end cap being secured to the upper end of the modified support post of FIGS. 5 and 6, with the bottom thereof being secured to a support base.

Similar numbers refer to similar parts throughout the drawings.

### DETAILED DESCRIPTION OF THE INVENTION

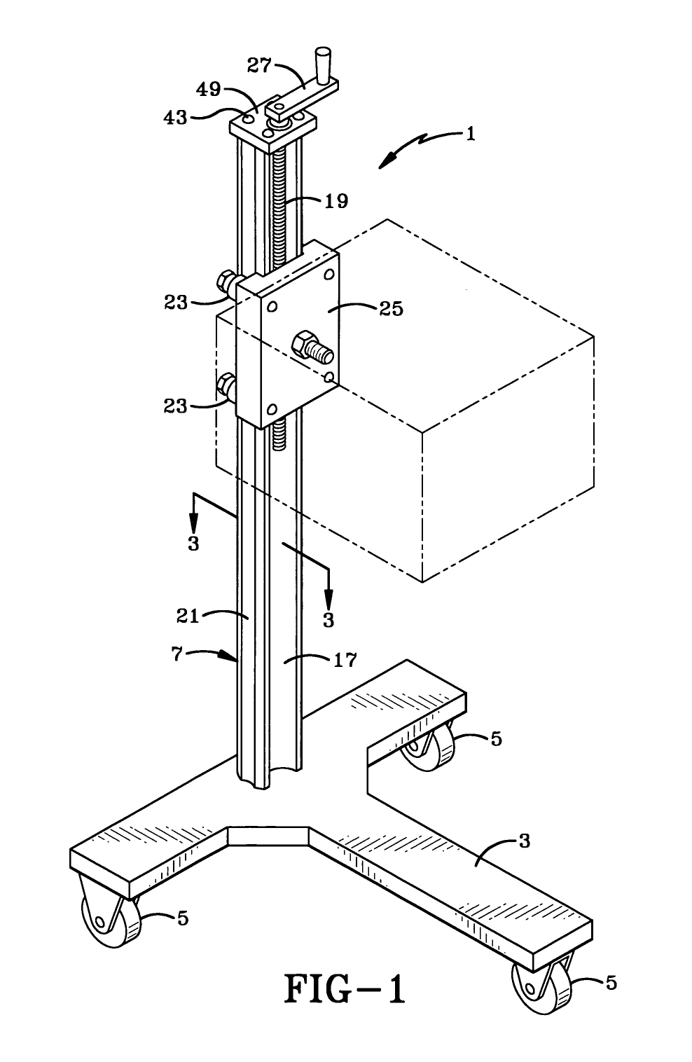

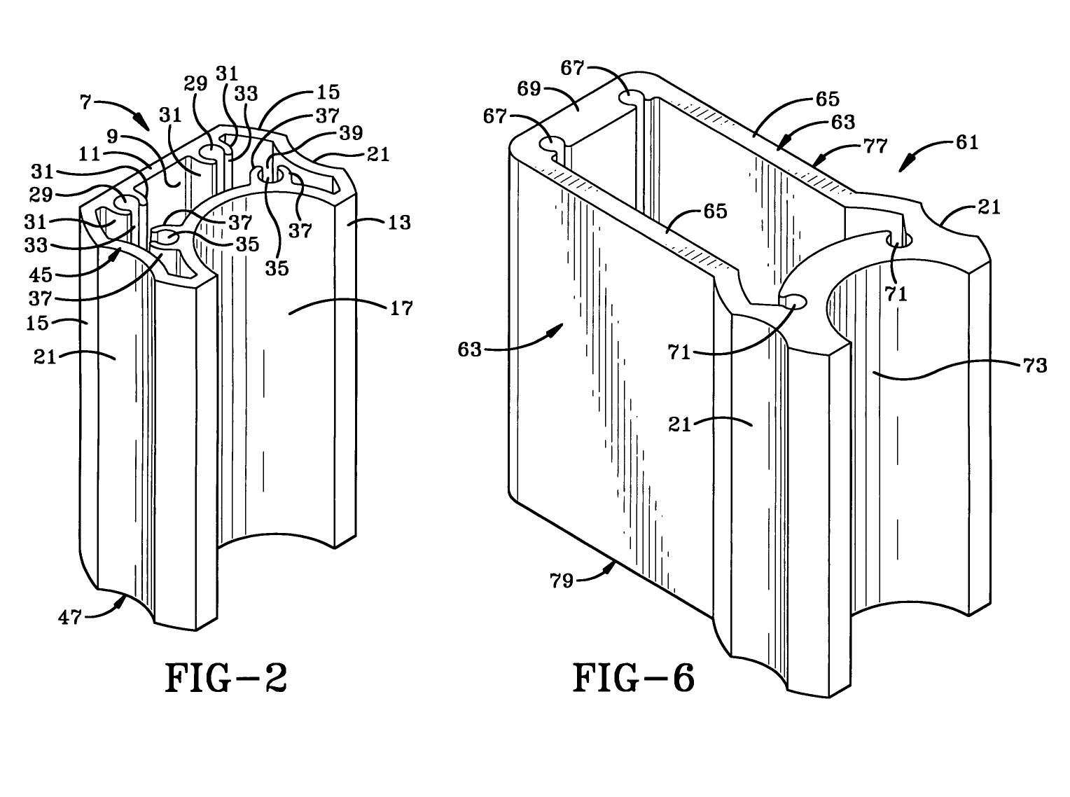

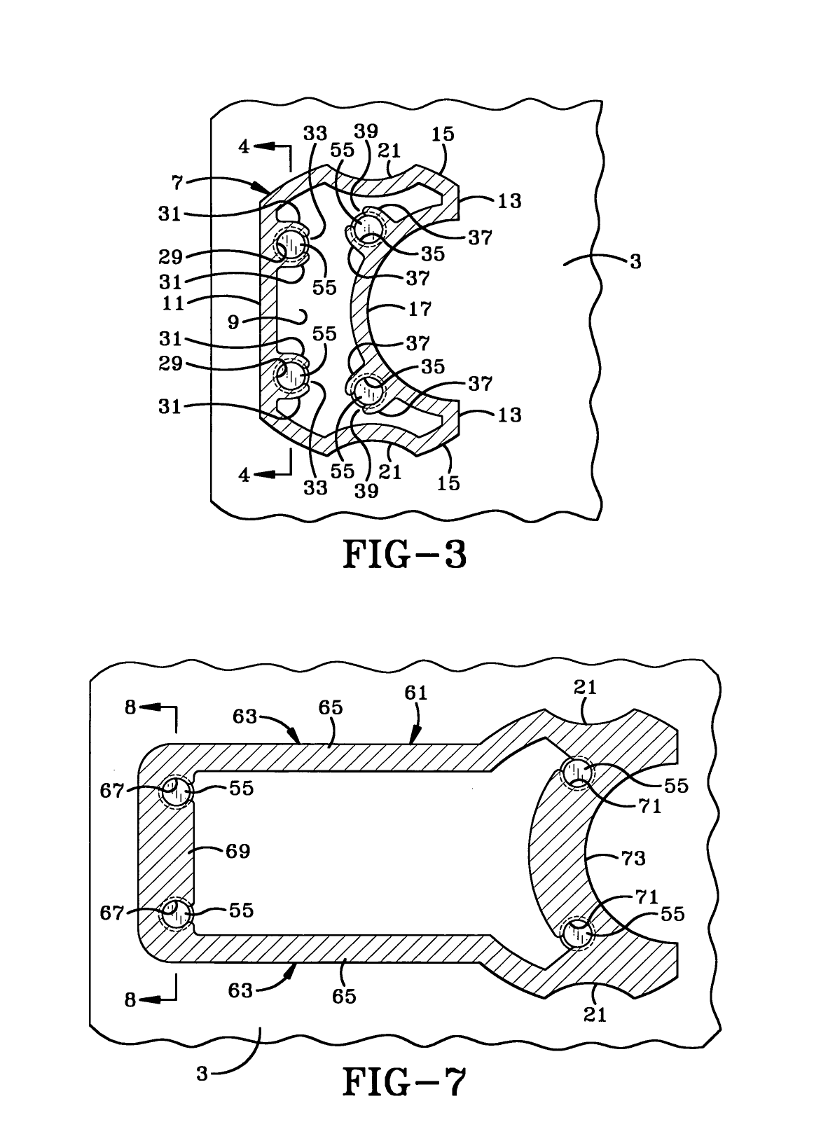

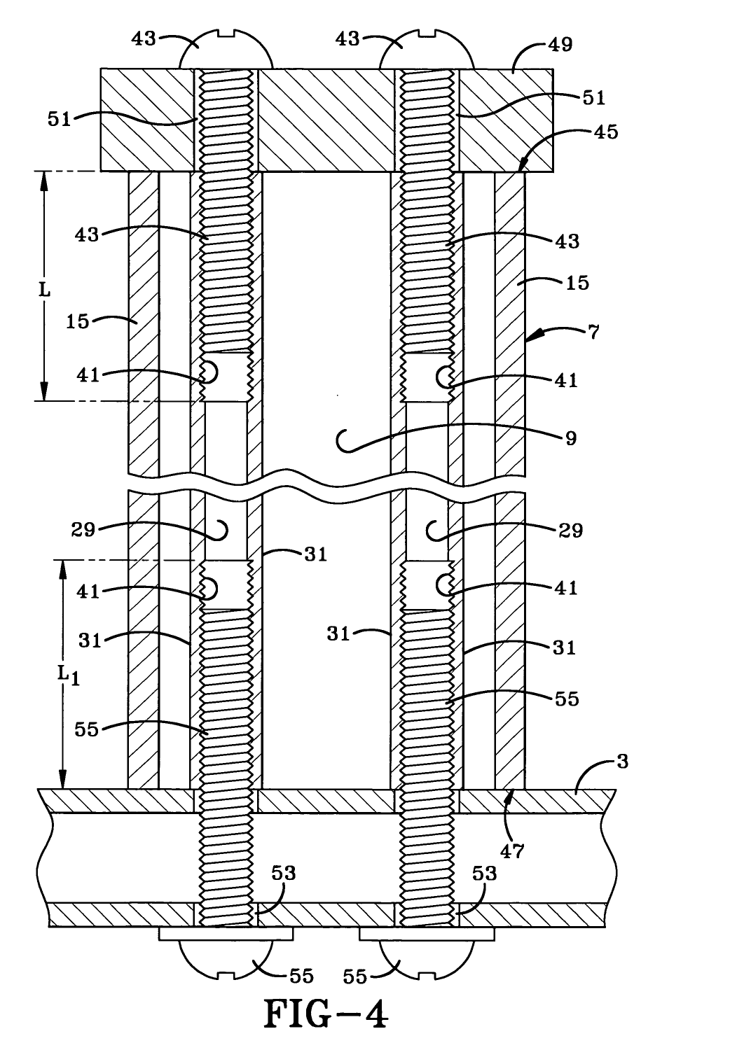

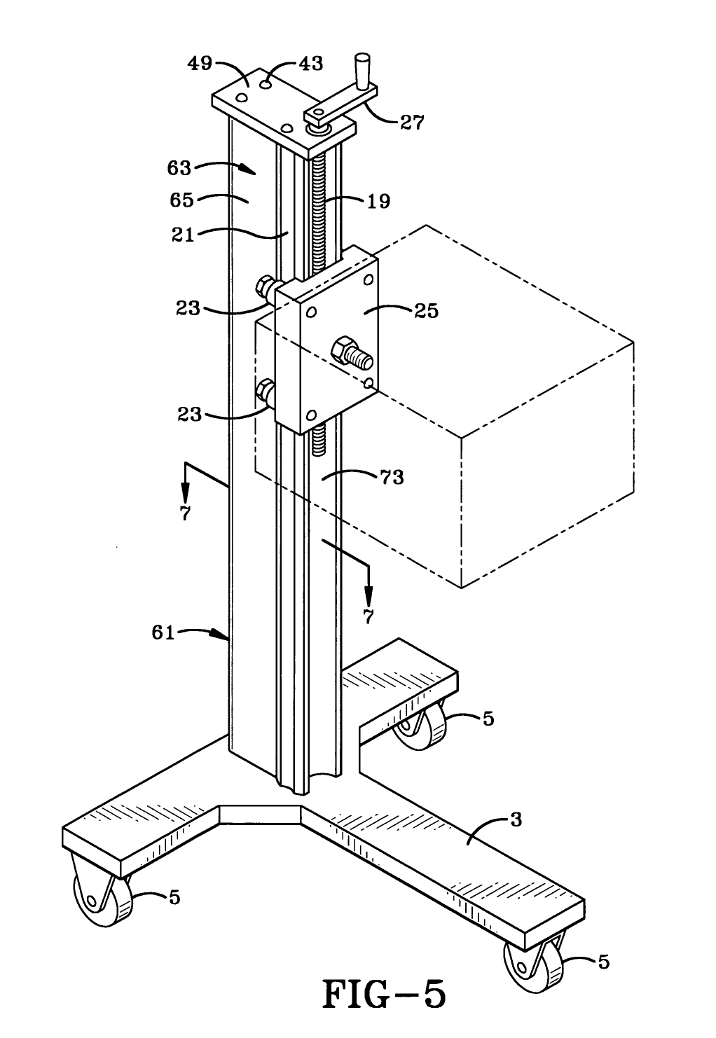

The improved hoist construction of the present invention is indicated generally at 1, with a first embodiment being shown in FIGS. 1-4. Hoist 1 includes a support base 3 which preferably is moveably mounted on a plurality of rollers 5, and is merely one example of the various types of fixed or movable bases on which the improved support post indicated generally at 7, is rigidly mounted. Support post 7 is shown particularly in FIGS. 2 and 3, and in accordance with one of the features of the invention is extruded, preferably of aluminum, and has a hollow tubular configuration with a hollow interior 9, a back wall 11, a front wall 13 and a pair of side walls 15. Front wall 13 is formed with a concave recess 17 along which a drive screw 19 is located to partially conceal the drive screw and prevent it from contacting adjacent personnel and equipment. An arcuate-shaped guide channel 21 is formed in each side wall 15 for receiving a pair of rollers 23 which moveably support a carriage plate 25. Carriage plate 25 is operationally engaged with drive screw 19 by a follower nut (not shown) and is accurately raised and lowered along support post 7 by a hand crank 27 or other type of mechanism for rotating drive screw 19. Further features of such a support carriage and the drive mechanism therefore is shown in detail in U.S. Pat. No. 5,544,860, the contents of which are incorporated herein by reference.

In accordance with one of the main features of the invention, a plurality of holes are formed in post 7 (FIG. 2) during the extrusion process and extend completely throughout the length of the post. Preferably, two of the holes indicated at 29, are formed in and adjacent to back wall 11, each by a pair of arcuate flanges 31 which form an opening 33, due to the features of the extrusion process. Each hole 29 has a smooth internal bore, and as indicated above, will extend throughout the length of the post. Another pair of holes 35 are formed on front wall 17 by a pair of arcuate-shaped flanges 37 with an intervening opening 39. The length of flanges 31 and 37 is approximately 300° with the intervening opening or slot therebetween being 60°.

In accordance with another feature of the invention, after the extrusion of post 7 which can either be formed in the desired length or cut from a longer piece of a similar-shaped extrusion, a short section of the formed holes 29 and 35 will be tapped as shown in FIGS. 3 and 4. This forms a short internally threaded section 41 having a length L (FIG. 4), which is sufficient to receive an externally threaded shaft of an attachment bolt 43. Holes 29 and 30 adjacent the top peripheral edge 45 will be tapped, and preferably the holes at the bottom peripheral edge 47 of post 7 will be tapped to a length L₁ extending inwardly into the post as shown in FIG. 4. These tapped holes enable an end cap plate 49 (FIGS. 1 and 4) to be easily mounted on peripheral edge 45 of post 7 by a plurality of fasteners 43 which extend through holes 51 formed in plate 49 and align with the internally threaded sections 41 of holes 29 as shown in FIG. 4. Likewise, holes 53 may be formed in base 3 for receiving another plurality of fasteners or bolts 55 which threadably engage the internally threaded sections 41 formed in the lower ends of holes 29 and 35 adjacent bottom peripheral edge 47 of post 7.

In the embodiment shown in FIGS. 1-4, back wall 11 preferably has a thickness of approximately 0.188 inches, side walls 15 having a thickness of 0.150 inches, and front wall 13 having a thickness of 0.211 inches. However, these thicknesses can vary considerably without affecting the concept of the invention. For example, back and front walls 11 and 13 can have a thickness of 0.15 inches and side walls 15 can have a thickness of 0.125 inches. Furthermore, threaded sections 41 will have a length of approximately 1½ inches, sufficient to receive most fasteners 43 and 55.

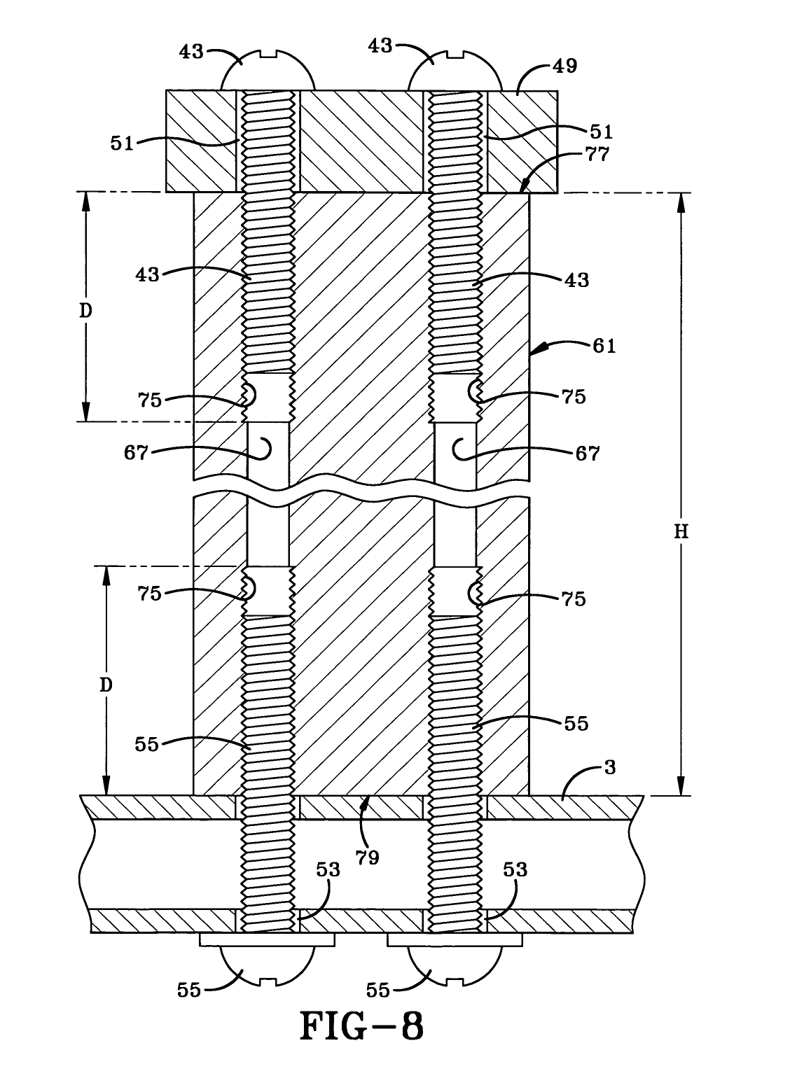

A modified embodiment of the support post is indicated generally at 61, and in shown in FIGS. 6-8, and is intended for supporting a heavier load than post 7 described above. Post 61 includes side walls 63 that have a pair of parallel spaced side wall sections 65 which extend at generally right angles from a back wall 69 and merge into the arcuate-shaped guide channels 21 as in post 7 described above. In the particular cross section of post 61, side walls 63 are longer in length than back wall 69, but can have other configurations without affecting the concept of the invention. Again, a pair of holes 67 are formed in back wall 69 and another pair of holes 71 are formed in front wall 73 during the extrusion process in the similar manner as are holes 29 and 35 discussed above. As shown in FIGS. 7 and 8, a short section of the extruded post holes is tapped to form internal threads 75 extending inwardly from an upper peripheral edge 77 or from the bottom peripheral edge 79 to receive fasteners 43 and 55 for mounting end cap 49 on post 61 or for mounting post 61 on base 3, either one or both depending upon the particular final configuration of the hoist.

Post 61 is similar in many respects to post 7 and will be used in applications requiring heavier loads to be supported and moved thereby. In the embodiment shown in FIG. 7, back wall 69 has a thickness of approximately 0.644 inches, side walls 63 have a thickness of approximately 0.306 inches, and front wall 73 has a thickness of approximately 0.644 inches. However, for certain applications back wall 69, side walls 63 and front wall 73 can have the same thickness, for example 0.75 inches.

In summary, the improved post construction and method of production of the present invention provides for an extremely simple and inexpensive post which is adapted to be mounted on a fixed or moveable base for moveably mounting a carriage thereon by the extrusion of the main post into a final desired cross-sectional configuration for receiving a drive screw and the carriage rollers, and requires only the subsequent tapping of formed holes at either the top and/or bottom for a short section of the formed holes for subsequent receiving externally threaded fasteners therein. Heretofore, even though the post was extruded of aluminum, it was solid and required drilling and then subsequently tapping the holes for the respective end plate or base mounting holes requiring additional manufacturing steps and costs and increased weight to the final post construction. The extruding of the post with the hollow interior and the appropriate through holes formed therein, which only require tapping a short section thereof, reduces the cost and the amount of material heretofore required, as well as the number and cost of manufacturing steps required to produce the completed post for incorporation in the host apparatus of the present invention.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An improved hoist apparatus for lifting, supporting and positioning a load including an elongated post, a base for supporting the post in an upright position, a drive screw, a carriage operatively connected to the drive screw for supporting a load and for movement along the post, the improvement comprising:
the post being formed of extruded aluminum having a back wall, a pair of side walls with arcuate guide channels formed thereon and a front wall having a recess formed therein forming a hollow interior, and a plurality of substantially smooth holes formed in certain of the walls and extending throughout the length of the post between top and bottom end edges of said post, said holes having an internally threaded section located adjacent at least one of the end edges of the post for receiving threaded fasteners therein for attaching the drive screw or base to the post.

2. The hoist defined in claim 1 including an end cap plate mounted on the top end edge of the post and a plurality of threaded fasteners extending through openings formed in the end cap plate and into the threaded section of certain of the post holes.

3. The hoist defined in claim 2 wherein the drive screw is rotatably supported on the end cap plate and located within the recess of the front wall.

4. The hoist defined in claim 1 including a plurality of threaded fasteners extending through holes formed in the base and into threaded sections of certain of the post holes adjacent the bottom peripheral edge of the post for securing the post on the base.

5. The hoist defined in claim 1 wherein the back wall has a thickness in the range of 0.15 inches and 0.75 inches, the side walls having a thickness in the range of 0.125 inches and 0.75 inches, and the front wall having a thickness of in the range of 0.15 inches and 0.75 inches.

6. The hoist defined in claim 1 wherein two of the holes are formed in the back wall and two other of the holes are formed in the front wall of the post.

7. The hoist defined in claim 1 wherein each of the holes is formed by a pair of arcuate flanges having a total arcuate length of approximately 300° providing a slot of approximately 60° therebetween which communicates with the hollow interior of the post.

8. The hoist defined in claim 1 wherein portions of the side wall are in a spaced parallel relationship to each other and extend at generally right angles from the back wall and have a length greater than said back wall; and in which the arcuate guide channels are formed at forward ends of the parallel portions adjacent the front wall.

9. A method for forming an elongated support post for a hoist apparatus comprising the steps of:
a) extruding an elongated tubular member having a back wall, front wall and a pair of side walls forming a hollow interior, said walls terminating in a pair of end edges;
b) forming a plurality of holes in certain of the walls of the tubular member during step (a), said holes extending throughout the length of the tubular member; and
c) forming internally threaded bores in certain of the formed holes adjacent at least one of the end edges of tubular member.

10. The method defined in claim 9 including the step of securing the post on the base by inserting a plurality of externally threaded fasteners through openings formed in the base and into certain of the internally threaded bores of the post.

11. The method defined in claim 9 including the step of securing an end cap plate on a top edge of the tubular member by inserting a plurality of externally threaded fasteners through openings formed in the end cap plate and into threaded engagement with certain of the threaded bores of the post.

12. The method defined in claim 11 including the step of moveably mounting a carriage on the post for movement therealong.

13. The method defined in claim 9 including the step of forming the front wall of the tubular member with a concave recess and forming a pair of concave arcuate guide channels in the side walls during step (a).

14. The method defined in claim 9 including the step of forming four holes in the tubular member during step (a), two of said holes being formed in the back wall, and two other of said holes being formed in the front wall.

15. The method defined in claim 9 including the step of forming a plurality of pairs of arcuate flanges extending into the hollow interior of the tubular member from the back and front walls to form the holes, said flanges having a total arcuate length of approximately 300° leaving an opening between ends of the flanges of approximately 60°.

16. The method defined in claim 9 including the step of forming portions of the side walls of the tubular member in a spaced parallel relationship to each other and at generally right angles to the back wall in step (a), with the parallel side wall portions having a length greater than the back wall.

17. The method defined in claim 9 including the step of forming the tubular member of aluminum in step (a) with the back wall having a thickness in the range of 0.15 inches and 0.75 inches, the side walls having a thickness in the range of 0.125 inches and 0.75 inches, and the front wall having a thickness of in the range of 0.15 inches and 0.75 inches.

18. A post for a hoist apparatus for supporting a carriage thereon, said post being an elongated extruded one-piece member having a hollow interior and a plurality of holes formed on certain walls of the post adjacent the hollow interior and extending throughout the length of said tubular member; and at least end portions of said holes being formed with an internally threaded section for receiving fasteners therein.

19. The post defined in claim 18 wherein each of the holes has an elongated side opening which communicates with the hollow interior of the tubular member.
